(19) United States
(12) Patent Application Publication
(10) Pub. No.: US 2024/0084177 A1
(43) Pub. Date: Mar. 14, 2024

(54) SEALANT COMPOSITION AND TIRE USING THE SAME

(71) Applicant: THE YOKOHAMA RUBBER CO., LTD., Hiratsuka-Shi, Kanagawa (JP)

(72) Inventors: Yuichiro KARASAWA, HIRATSUKA SHI, KANAGAWA (JP); Takeaki SAIKI, HIRATSUKA-SHI, KANAGAWA (JP); Takahiro OKAMATSU, HIRATSUKA-SHI, KANAGAWA (JP)

(21) Appl. No.: 18/271,882

(22) PCT Filed: Dec. 24, 2021
(86) PCT No.: PCT/JP2021/048121

§ 371 Date: Jul. 12, 2023

(30) Foreign Application Priority Data
Jan. 26, 2021 (JP) 2021-009967

(51) Int. Cl. C09J 107/02; C08K 5/405; C08K 5/44; C08K 5/47; C08L 7/00; C08L 9/00; C08L 91/00

(52) U.S. Cl. CPC C09J 107/02; C08K 5/405; C08K 5/44; C08K 5/47; C08L 7/00; C08L 9/00; C08L 91/00

(57) ABSTRACT

A sealant composition of the present invention includes a rubber component (A), a tackifier (B), and a plasticizer (C), in which the tackifier (B) has a softening point of 50° C. or higher, the plasticizer (C) has a dynamic viscosity at 40° C. of 2500 mm²/s or less, and a mass ratio of (C)/(B) of the plasticizer (C) to the tackifier (B) is 0.35 or more. Thus, the sealant composition can provide improved sealability, viscosity temperature dependency, and fluidity during storage of a tire.

### TECHNICAL FIELD

The present invention relates to a sealant composition and a tire using the same.

### BACKGROUND ART

Among pneumatic tires, a pneumatic tire is known that is provided with a sealant layer disposed on an inner side of an innerliner layer in a tire radial direction in a tread portion. In such a pneumatic tire, when a foreign matter such as a nail or the like penetrates into the tread portion, the sealant flows into a through-hole, which makes it possible to suppress a decrease in air pressure and to maintain travel.

For example, Patent Document 1 below discloses a self-sealing elastomer composition including an unsaturated diene elastomer, hydrocarbon resin between 30 phr and 90 phr, and a filler of 0 to less than 30 phr.

Also, Patent Document 2 below discloses a self-sealing elastomer composition for use as a puncture preventative layer in an inflatable article, which includes at least an unsaturated diene elastomer as a main elastomer having a repeating unit content derived from a conjugated diene of more than 30 mol %, hydrocarbon resin having a mass content of between 30 phr and 90 phr, a liquid plasticizer having a glass transition temperature (Tg) of lower than −20° C. and a mass content of 5 phr to less than 60 phr, and a filler of 0 to less than 30 phr.

### CITATION LIST

### Patent Literature

Patent Document 1: JP 5646474 B
Patent Document 2: JP 5525522 B

### SUMMARY OF INVENTION

### Technical Problem

However, in the related art described above, there are problems in the sealability against through-holes formed when foreign matter such as nails or the like penetrate into the tread portion, in the viscosity temperature dependency of the sealant composition, and in the fluidity of the sealant composition during storage of the tire, and a solution to these problems is required.

An object of the present invention is to solve the aforementioned problems.

### Solution to Problem

As a result of diligent researches, the inventors found that the problems described above can be solved by the sealant composition formed by blending specific amounts of a tackifier and a plasticizer in a rubber component, and thus the present invention can be completed.

The present invention provides a sealant composition forming a sealant layer of a pneumatic tire provided with the sealant layer on a tire inner surface, the sealant composition including:
a rubber component (A);
a tackifier (B); and
a plasticizer (C),
the tackifier (B) having a softening point of 50° C. or higher,
the plasticizer (C) having a dynamic viscosity at 40° C. of 2500 mm²/s or less, and
a mass ratio of (C)/(B) of the plasticizer (C) to the tackifier (B) being 0.35 or more.

### Advantageous Effects of Invention

The sealant composition of the present invention includes the rubber component (A), the tackifier (B), and the plasticizer (C). The tackifier (B) has a softening point of 50 or higher. The plasticizer (C) has a dynamic viscosity at 40° C. of 2500 mm²/s or less. A mass ratio of (C)/(B) of the plasticizer (C) to the tackifier (B) is 0.35 or more. According to the configuration described above, the softening point of the tackifier (B) and the dynamic viscosity at a specific temperature of the plasticizer (C) are optimized, and the sealant composition easily flows into through-holes formed in the tread portion to increase sealability and reduce viscosity temperature dependency of the sealant composition. As a result, the sealant composition can be prevented from flowing due to the influence of heat or centrifugal forces applied during travel, and the sealant composition can be inhibited from flowing during storage of the tire.

### DESCRIPTION OF EMBODIMENTS

The present invention will be described in further detail below.

### (A) Rubber Component

Examples of a rubber component (A) used in the present invention include diene rubber such as natural rubber (NR), synthetic isoprene rubber (IR), butadiene rubber (BR), styrene-butadiene copolymer rubber (SBR), acrylonitrile-butadiene copolymer rubber (NBR), ethylene-propylene-diene terpolymer (EPDM), butyl rubber, and the like. These may be used alone, or two or more may be used in combination.

In particular, from the perspective of improving the effects of the present invention, the rubber component (A) is preferably NR, IR, SBR, BR, or a blend thereof.

### (B) Tackifier

An example of a tackifier (B) used in the present invention includes hydrocarbon resin. An example of the hydrocarbon resin includes petroleum resin such as aromatic hydrocarbon resin that is manufactured by polymerizing components obtained by performing treatments such as distillation, decomposition, and reforming on crude oil, or petroleum resin such as saturated or unsaturated hydrocarbon resin. Examples of the petroleum resin include C5 petroleum resin (aliphatic petroleum resin formed by polymerizing fractions such as isoprene, 1,3-pentadiene, cyclopentadiene, methylbutene, and pentene), C9 petroleum resin (aromatic petroleum resin formed by polymerizing fractions such as α-methylstyrene, o-vinyl toluene, m-vinyl toluene, and p-vinyl toluene), C5C9 copolymer petroleum resin, and the like.

Additionally, in the present invention, the softening point of the tackifier (B) needs to be 50° C. or higher. When the softening point is lower than 50° C., the problem of fluidity deterioration occurs.

The softening point of the tackifier (B) is preferably 50 to 150° C., and more preferably 80 to 120° C.

Note that a softening point is a value measured by a ring and ball softening point measuring device in accordance with JIS K6220-1:2001.

### (C) Plasticizer

Examples of the plasticizer used in the present invention are a carboxylic acid ester plasticizer, a phosphoric acid ester plasticizer, a sulfonic acid ester plasticizer, oil, liquid rubber, and the like.

Examples of the carboxylic acid ester plasticizer include publicly known phthalic acid esters, isophthalic acid esters, tetrahydrophthalic acid esters, adipic acid esters, maleic acid esters, fumaric acid esters, trimellitic acid esters, linoleic acid esters, oleic acid esters, stearic acid esters, ricinoleic acid esters, and the like.

Examples of the phosphoric acid ester plasticizer include publicly known trimethyl phosphate, triethyl phosphate, tributyl phosphate, tri(2-ethylhexyl) phosphate, 2-ethylhexyl diphenyl phosphate, tributoxyethyl phosphate, triphenyl phosphate, cresyl diphenyl phosphate, isodecyl diphenyl phosphate, tricresyl phosphate, tritolyl phosphate, trixylenyl phosphate, tris(chloroethyl) phosphate, diphenyl mono-o-xenyl phosphate, and the like.

Examples of the sulfonic acid ester plasticizer include publicly known benzene sulfone butylamide, toluenesulfonamide, N-ethyl-toluenesulfonamide, N-cyclohexyl-p-toluenesulfonamide, and the like.

Examples of the oil include known mineral oils such as paraffinic oil, naphthenic oil, and aromatic oil.

Examples of the liquid rubber include liquid polyisoprene, liquid polybutadiene, liquid polystyrene butadiene, and the like, and the average molecular weight thereof (Mn) is preferably 1000 to 100000, and more preferably 1500 to 75000. Note that the average molecular weight (Mn) in the present invention refers to an average molecular weight determined by gel permeation chromatography (GPC) based on calibration with polystyrene.

The liquid rubber used in the present invention is liquid at 23° C. As a result, the liquid rubber is distinguished from the aforementioned rubber component that is solid at this temperature.

Of the rubbers described above, oil is preferable as the plasticizer from the perspective of improving the effects of the present invention.

Also, in the present invention, the dynamic viscosity of the plasticizer (C) at 40° C. needs to be 2500 mm²/s or less. When the dynamic viscosity exceeds 2500 mm²/s, the viscosity of the sealant increases and the sealant may not exhibit sealability.

The dynamic viscosity of the plasticizer (C) at 40° C. is preferably 1 to 2000 mm²/s, and more preferably 10 to 1000 mm²/s.

Note that dynamic viscosity is a value measured in accordance with JIS K 2283:2000.

Additionally, the sealant composition of the present invention can be blended with a crosslinking agent. Examples of the crosslinking agent include sulfur, organic peroxide, and the like. In the present invention, by using sulfur in particular as the crosslinking agent, sealability and viscosity temperature dependency can be preferably improved.

### Blending Ratio of Sealant Composition

The sealant composition of the present invention includes a rubber component (A), a tackifier (B), and a plasticizer (C), and a mass ratio of (C)/(B) of the plasticizer (C) to the tackifier (B) is 0.35 or more. When (C)/(B) is less than 0.35, the viscosity temperature dependency of the sealant composition and the fluidity of the sealant composition during storage of the tires deteriorate.

(C)/(B) is preferably 0.35 to 3.0, and more preferably 0.35 to 2.0.

Further, in the sealant composition of the present invention, the blended amount of the plasticizer (C) is preferably 150 parts by mass or less per 100 parts by mass of the rubber component (A). According to such an embodiment, fluidity is improved.

Furthermore, the sealant composition of the present invention may be formed by blending, per 100 parts by mass of the rubber component (A), preferably 5 to 100 parts by mass of the tackifier (B), or more preferably 20 to 60 parts by mass, and 10 to 150 parts by mass of the plasticizer (C), or more preferably 30 to 100 parts by mass.

Also, when a crosslinking agent such as sulfur is blended, the blended amount thereof is preferably 0.1 to 10 parts by mass per 100 parts by mass of the rubber component (A).

### Other Components

Various additives such as a vulcanizing or crosslinking agent, a vulcanizing or cross-linking accelerator, zinc oxide, an anti-aging agent, and carbon black other than the aforementioned components can be blended in the sealant composition of the present invention. Such additives can be kneaded by a typical method to form a composition, and the blended amount of the additives can be a typical blended amount in the related art unless contrary to the object of the present invention.

Examples of the vulcanization accelerator include known guanidine-based, thiazole-based, sulfenamide-based, thiourea-based, dithiocarbamate-based, xanthogenate-based, and thiuram-based vulcanization accelerators. In particular, one or more types selected from a thiazole-based vulcanization accelerator, a sulfenamide-based vulcanization accelerator, a thiourea-based vulcanization accelerator, and a thiuram-based vulcanization accelerator are desirable. The blended amount of the vulcanization accelerator is preferably 0.1 to 10 parts by mass per 100 parts by mass of the rubber component (A).

When sulfur is blended as a vulcanizing agent, the sealant composition of the present invention can be dynamically cross-linked.

The sealant composition of the present invention can be provided as a sealant layer on an inner side of an innerliner layer in a tire radial direction in a tread portion in a pneumatic tire. The sealant layer can be formed by attaching a sheet-shaped molded sealant made of the sealant composition of the present invention to the entire circumference of the tire inner surface. Alternatively, the sealant layer can be formed by spirally attaching a string-shaped or band-shaped molded sealant made of the sealant composition of the present invention to the tire inner surface. With the sealant layer, when a foreign matter such as a nail or the like penetrates into the tread portion, the sealant constituting the sealant layer flows into the through-hole, and as a result, a decrease in air pressure can be suppressed and travel can be maintained. The sealant layer has a thickness of, for example, 0.5 mm to 5.0 mm.

### EXAMPLES

The present invention will be described in further detail by way of examples and comparative examples, but the present invention is not limited by these examples. Additionally, in the following examples, “parts” means “parts by mass”.

### Examples 1 to 8 and Comparative Examples 1 to 2

According to the composition (parts by mass) shown in Table 1, kneading is performed for 40 minutes in a 1.7-L sealed Banbury Mixer, and a rubber composition was obtained. Next, the obtained rubber composition was press-vulcanized in a predetermined mold at 180° C. for 10 minutes to obtain a sealant having a thickness of 3 mm.

In a pneumatic tire having a tire size of 215/55R17, including a tread portion, a pair of sidewall portions, and a pair of bead portions, and including a sealant layer made of a sealant on an inner side of the innerliner layer in a tire radial direction in the tread portion, the sealant was attached as the sealant layer to manufacture various test tires. The following physical properties were measured for the obtained test tires.

### Sealability:

The test tires were assembled on wheels having a rim size of 17×7 J and mounted on a test vehicle, with an initial air pressure of 250 kPa, a 4 mm-diameter nail was driven into the tread portion, and then the test tires were left to stand for one hour after the nail was removed. Thereafter, the air pressure was measured. The evaluation results were indicated by “good” in a case where the air pressure after the tire was left to stand was 230 kPa or higher and 250 kPa or lower, by “fair” in a case where the air pressure after the tire was left to stand was 200 kPa or higher and less than 230 kPa, and by “poor” in a case where the air pressure after the tire was left to stand was less than 200 kPa.

### Fluidity of Sealant:

The test tires were assembled on wheels having a rim size of 16×6.5 J, mounted on a drum testing machine, and subjected to high deflection test with an air pressure of 160 kPa, a load of 8.5 kN, and a traveling speed of 80 km/h for 80 hours, and then the flow state of the sealant was examined. The evaluation results were as follows: Given that, when the 3 mm thickness of the sealant was 1.5 mm or less after testing at each position from the sealant end, it was determined that flow was observed, the case where no flow was observed at a position 1 cm away from the sealant end was indicated by “good”, the case where flow was observed at a position 1 cm away from the sealant end and no flow was observed at a position 2 cm away from the sealant end was indicated by “fair”, and the case where flow was observed at a position 2 cm away from the sealant end was indicated by “poor”.

Storability: The test tires were left in an oven at 30° C. for one week to examine storability. The evaluation results are determined by fluidity from the outer end in the tire width direction of the sealant layer. The case where no sealant flow was observed is indicated by “good”, the case where sealant flow occurred in a region within 1 cm away from the end is indicated by “fair”, and the case where sealant flow occurred in a region 1 cm or more away from the end is indicated by “poor”.

The results are shown in Table 1.

TABLE 1

| | | Comparative | Comparative | |
|---|---|---|---|---|
| Blend | | Example 1 | Example 2 | Example 1 |
| NR | 1) | 100 | 60 | 60 |
| SBR | 2) | | 40 | 40 |
| Plasticizer 1 | 3) | 15 | | |
| Plasticizer 2 | 4) | | 30 | 30 |
| Plasticizer 3 | 5) | | | |
| Tackifier 1 | 6) | 50 | | |
| Tackifier 2 | 7) | | 120 | 30 |
| Carbon black | 8) | 1 | | |
| Sulfur | 9) | 0.5 | 0.5 | 0.5 |
| Vulcanization | 10) | 0.3 | | |
| accelerator DPG | | | | |
| Vulcanization | 11) | | 1 | 1 |
| accelerator DM-PO | | | | |
| (C)/(B) | | 0.30 | 0.25 | 1.00 |
| Sealability | | Good | Good | Good |
| Fluidity | | Poor | Poor | Good |
| Storability | | Good | Good | Good |

| | | Exam- | Exam- | Exam- | Exam- |
|---|---|---|---|---|---|
| Blend | | ple 2 | ple 3 | ple 4 | ple 5 |
| NR | 1) | 60 | 60 | 60 | 60 |
| SBR | 2) | 40 | 40 | 40 | 40 |
| Plasticizer 1 | 3) | | | | |
| Plasticizer 2 | 4) | 30 | 30 | 60 | 60 |
| Plasticizer 3 | 5) | | | | |
| Tackifier 1 | 6) | | | | |
| Tackifier 2 | 7) | 60 | 80 | 30 | 60 |
| Carbon black | 8) | | | | |
| Sulfur | 9) | 0.5 | 0.5 | 0.5 | 0.5 |
| Vulcanization | 10) | | | | |
| accelerator DPG | | | | | |
| Vulcanization | 11) | 1 | 1 | 1 | 1 |
| accelerator DM-PO | | | | | |
| (C)/(B) | | 0.50 | 0.38 | 2.00 | 1.00 |
| Sealability | | Good | Good | Good | Good |
| Fluidity | | Good | Good | Good | Good |
| Storability | | Good | Good | Good | Good |

| Blend | | Example 6 | Example 7 | Example 8 |
|---|---|---|---|---|
| NR | 1) | 60 | 60 | 60 |
| SBR | 2) | 40 | 40 | 40 |
| Plasticizer 1 | 3) | | | |
| Plasticizer 2 | 4) | | 60 | 60 |
| Plasticizer 3 | 5) | 30 | | |
| Tackifier 1 | 6) | | | |
| Tackifier 2 | 7) | 30 | 30 | 30 |
| Carbon black | 8) | | | |
| Sulfur | 9) | 0.5 | 0.75 | 1 |
| Vulcanization | 10) | | | |
| accelerator DPG | | | | |
| Vulcanization | 11) | 1 | 1 | 1 |
| accelerator DM-PO | | | | |
| (C)/(B) | | 1.00 | 2.00 | 2.00 |
| Sealability | | Good | Good | Good |
| Fluidity | | Good | Good | Good |
| Storability | | Good | Good | Good |

*1): NR (SIR20)
*2): SBR (Nipol 1502 available from Zeon Corporation)
*3): Plasticizer 1 (Ricon 154, liquid butadiene rubber available from CRAY VALLEY)
*4): Plasticizer 2 (Diana Process Oil NP250 available from Idemitsu Kosan Co., Ltd., dynamic viscosity at 40° C. = 274.5 mm²/s)
*5): Plasticizer 3 (Trade name Extract No. 4S available from SHOWA SHELL SEKIYU K.K., dynamic viscosity at 40° C. = 2158 mm²/s)
*6): Tackifier 1 (Escorez 2101, C5/C9 petroleum resin available from Exxon Mobil Corporation, softening point = 90° C.)
*7): Tackifier 2 (T-REZ RC115, C5 petroleum resin available from ENEOS Corporation, softening point = 113.1° C.)
*8): Carbon black (Carbon black N772)
*9): Sulfur (Golden Flower oil treated sulfur powder available from Tsurumi Chemical Industry Co., Ltd.)
*10): Vulcanization accelerator DPG (NOCCELER D available from Ouchi Shinko Chemical Industrial Co., Ltd.)
*11): Vulcanization accelerator DM-PO (SANCELER DM-PO available from Sanshin Chemical Industry Co., Ltd.)

From the results shown in Table 1, since the sealant composition of each Example includes a rubber component (A), a tackifier (B), and a plasticizer (C), and the softening point of the tackifier (B) is 50° C. or higher, the dynamic viscosity of the plasticizer (C) at 40° C. is 2500 mm²/s or less, and the mass ratio of the plasticizer (C) to the tackifier (B) is 0.35 or more, good results were obtained in all of sealability, fluidity (viscosity temperature dependency), and storability.

On the other hand, in Comparative Examples 1 and 2, since (C)/(B) is less than 0.35, the fluidity and the storability deteriorated.

1. A sealant composition forming a sealant layer of a pneumatic tire provided with the sealant layer on a tire inner surface, the sealant composition comprising:
a rubber component (A);
a tackifier (B); and
a plasticizer (C),
the tackifier (B) having a softening point of 50° C. or higher,
the plasticizer (C) having a dynamic viscosity at 40° C. of 2500 mm²/s or less, and
a mass ratio of (C)/(B) of the plasticizer (C) to the tackifier (B) being 0.35 or more.

2. The sealant composition according to claim 1, wherein the rubber component (A) is natural rubber, synthetic isoprene rubber, styrene-butadiene copolymer rubber, butadiene rubber, or a blend of the rubbers.

3. The sealant composition according to claim 1, wherein the plasticizer (C) is at least one type selected from paraffinic oil, naphthenic oil, and aroma oil.

4. The sealant composition according to claim 1, wherein the dynamic viscosity of the plasticizer (C) at 40° C. is 1 to 2000 mm²/s.

5. The sealant composition according to claim 1, wherein a blended amount of the plasticizer (C) is 150 parts by mass or less per 100 parts by mass of the rubber component (A).

6. The sealant composition according to claim 1, wherein the softening point of the tackifier (B) is 50 to 150° C.

7. The sealant composition according to claim 1, wherein the tackifier (B) is hydrocarbon resin.

8. The sealant composition according to claim 7, wherein the hydrocarbon resin is C5 petroleum resin, C9 petroleum resin, or C5C9 copolymer petroleum resin.

9. The sealant composition according to claim 1, wherein the mass ratio of (C)/(B) of the plasticizer (C) to the tackifier (B) is 0.35 to 3.0.

10. The sealant composition according to claim 1, wherein 0.1 to 10 parts by mass of sulfur are included as a crosslinking agent per 100 parts by mass of the rubber component (A).

11. The sealant composition according to claim 1, further comprising, as a vulcanization accelerator, at least one or more types selected from a thiazole-based vulcanization accelerator, a sulfenamide-based vulcanization accelerator, a thiourea-based vulcanization accelerator, and a thiuram-based vulcanization accelerator.

12. A tire using the sealant composition according to claim 1.
